(19) United States
(12) Patent Application Publication
(10) Pub. No.: US 2026/0047520 A1
(43) Pub. Date: Feb. 19, 2026

(54) GENERATING GROUND TRUTH AND CALIBRATION OF HARVESTER LOSS SENSING SYSTEM

(71) Applicant: Deere & Company, Moline, IL (US)

(72) Inventor: John P. JUST, Ames, IA (US)

(21) Appl. No.: 18/802,918

(22) Filed: Aug. 13, 2024

(51) Int. Cl. A01D 41/127

(52) U.S. Cl. CPC A01D 41/1273

(57) ABSTRACT

A combine harvester has a loss sensing system that senses loss and generates a signal indicative of the sensed loss. A metering system injects a known amount of additional material to be sensed by the loss sensing system. A calibration system compares the signal generated by the loss sensing system to the known amount of injected material and calibrates the loss sensing system based upon the known amount of injected material and the signal from the loss sensing system.

### FIELD OF THE DESCRIPTION

The present description relates to agricultural equipment. More specifically, the present description relates to sensing ground truth loss and calibrating a loss sensing system on a combine harvester.

### BACKGROUND

There are many different types of agricultural harvesters. One agricultural harvester is a combine harvester.

Combine harvesters often include a crop engaging header that engages crop in a field and severs the crop and gathers the crop toward crop processing functionality in the harvester. The harvester includes a threshing/separator system as well as a winnowing/cleaning system. Once the harvested material passes through the threshing/separator system and the winnowing/cleaning system, it is often transferred to a clean grain tank.

Many combine harvesters have loss sensors that are mounted to the combine harvester in an attempt to sense the amount of grain lost during the harvesting operation. In some examples, one or more loss sensors are mounted to sense grain loss at the threshing/separator system. Other loss sensors may be mounted on the combine harvester to sense loss from the winnowing/cleaning system.

The discussion above is merely provided for general background information and is not intended to be used as an aid in determining the scope of the claimed subject matter.

### SUMMARY

A combine harvester has a loss sensing system that senses loss and generates a signal indicative of the sensed loss. A metering system injects a known amount of additional material to be sensed by the loss sensing system. A calibration system compares the signal generated by the loss sensing system to the known amount of injected material and calibrates the loss sensing system based upon the known amount of injected material and the signal from the loss sensing system.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a partial pictorial, partial schematic diagram of one example of a combine harvester.

FIG. 2 is a block diagram of a portion of the combine harvester.

FIG. 3 is a flow diagram illustrating one example of the operation of a loss processing system.

FIG. 4 is a block diagram showing one example of a loss processing system in more detail.

FIGS. 5A and 5B (collectively referred to herein as FIG. 5) show a flow diagram illustrating one example of a more detailed operation of a loss processing system.

FIG. 6 is a block diagram showing one example of a combine harvester deployed in a remote server environment.

FIGS. 7, 8, and 9 show examples of mobile devices that can be used in architectures and systems shown in other figures.

FIG. 10 is a block diagram of one example of a computing environment that can be used in architectures and systems shown in other figures.

### DETAILED DESCRIPTION

For the purposes of promoting an understanding of the principles of the present disclosure, reference will now be made to the examples illustrated in the drawings, and specific language will be used to describe the same. It will nevertheless be understood that no limitation of the scope of the disclosure is intended. Any alterations and further modifications to the described devices, systems, methods, and any further application of the principles of the present disclosure are fully contemplated as would normally occur to one skilled in the art to which the disclosure relates. In particular, it is fully contemplated that the features, components, and/or steps described with respect to one example may be combined with the features, components, and/or steps described with respect to other examples of the present disclosure.

As discussed above, combine harvesters often have a loss sensing system that includes one or more different loss sensors mounted to the combine harvesters to sense grain loss or other crop loss in the threshing/separator system and in the winnowing/cleaning system and generate a loss sensor signal, as well as a loss computation system that uses a transfer function or other logic to estimate or calculate loss lased on the loss sensor signal. While the present discussion applies to any type of loss sensor in one example the loss sensors are strike sensors that sense grain strikes in the waste material that is ejected from the threshing/separator system and the winnowing/cleaning system. The loss sensors generate a signal indicative of the sensed loss. For instance, strike sensors generate a signal indicative of the number of grain strikes per unit time or per distance traveled. The transfer function or other algorithm operates on the sensor signal to generate an output indicative of loss in, for example, units of bushels per acre. It can be difficult to calibrate the loss sensing system so that the loss signal is accurate. One way of calibrating loss sensors is to obtain a ground truth loss value indicative of actual grain loss in a field and compare that ground truth loss value to the output generated by the loss sensing system indicative of sensed or estimated loss. However, this presents significant problems. Current methods for obtaining a ground truth loss value are expensive and time consuming. Often, such methods involve setting pans or other gathering devices on the field to gather lost crop as the harvester proceeds over that area of the crop. The amount of crop in the pans must then be quantified to identify a loss value. Other methods of obtaining a ground truth loss value involve running screen cleaners or driving a separate loss sensing machine behind a harvester. These methods are all very time consuming and expensive and it is often very difficult to scale the ground truth values across fields and machines.

Further, many sources contribute to error in sensing loss. Environmental and system variables can affect sensed loss and therefore a ground truth loss value must be obtained in many different types of environmental and system conditions in order to build a robust model for estimating loss based on loss sensor signals. Some environmental variables that may affect the accuracy of a loss sensing system include a condition of material other than grain (MOG), crop moisture, soil moisture, terrain (e.g., whether the combine harvester is traveling uphill, downhill, or on a side hill), ambient weather conditions and crop kernel characteristics. Some system variables that affect the accuracy of a loss sensing system involve sensor variables, such as the variability of across different sensors, degradation in the sensing capabilities of the sensor over time, sensor saturation in high loss environments, impact by tailings, among others.

The present description thus describes a system which injects a known quantity of grain or grain proxy material (such as wood pellets, other pellets, or other proxy materials) into a flow of material that is sensed by a loss sensing system. The loss signal value is also monitored to determine how that signal value changes based upon the injection of a known quantity of loss material. The change in the loss signal induced by injection of the known quantity of material can be used to calibrate the sensor itself (sensor settings, sensitivity, among other things), and/or to calibrate the transfer function or logic in order to more accurately estimate the actual loss based upon the loss sensor signal. In one example, the injection of the known quantity of material can be done while the combine harvester is out-of-crop (or not harvesting) to obtain a baseline value for sensor calibration. The injection of a known quantity of material can also be repeatedly performed under different conditions while the harvester is in-crop (or harvesting) in order to calibrate the crop loss sensing system to accommodate for different conditions. In another example, the injection of known material can be repeated and the amount of injected material can be changed (such as increased) during each repetition. This repetition and the variation in the amount of material injected can be used to calibrate the loss sensing system as well. Further, the injected material can be injected directly to the loss sensor itself, or into a flow of material that reaches the loss sensor. The calibration data can also be stored for use in training estimation models, or sensor system design, among other things.

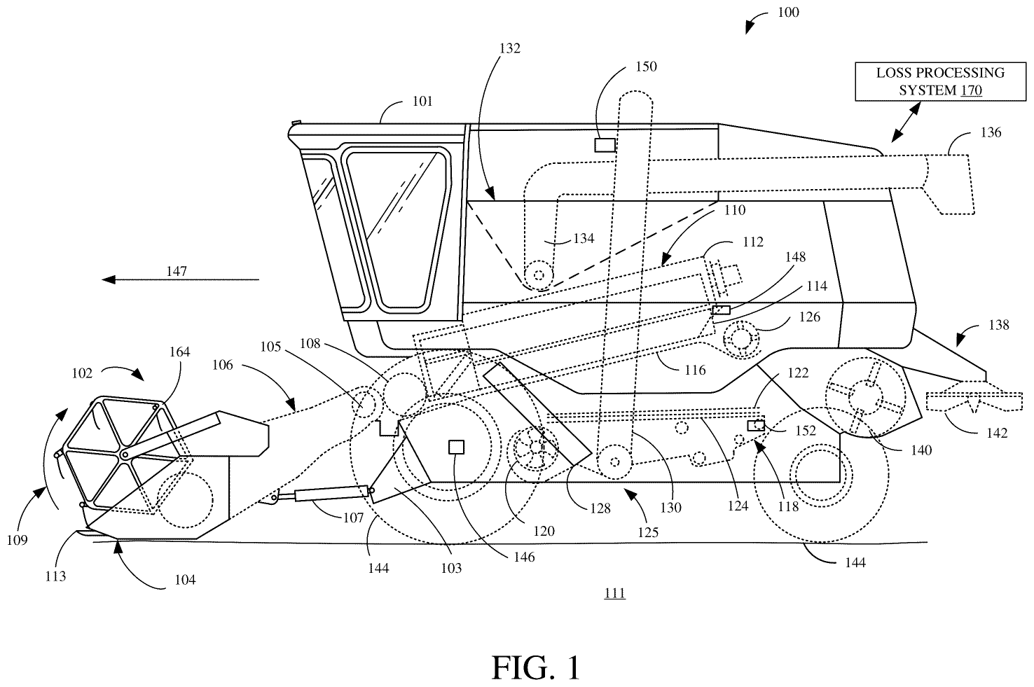

FIG. 1 is a partial pictorial, partial schematic, illustration of a self-propelled agricultural harvester 100. In the illustrated example, agricultural harvester 100 is a combine harvester.

As shown in FIG. 1, agricultural harvester 100 illustratively includes an operator compartment 101, which can have a variety of different operator interface mechanisms, for controlling agricultural harvester 100. Agricultural harvester 100 includes front-end equipment, such as a header 102 (with an associated reel 164), and a cutter generally indicated at 104. Agricultural harvester 100 also includes a feeder house 106, a feed accelerator 108, and a thresher generally indicated at 110. The feeder house 106 and the feed accelerator 108 form part of a material handling subsystem 125. Header 102 is pivotally coupled to a frame 103 of agricultural harvester 100 along pivot axis 105. One or more actuators 107 drive movement of header 102 about axis 105 in the direction generally indicated by arrow 109. Thus, a vertical position of header 102 (the header height) above ground 111 over which the header 102 travels is controllable by actuating actuator 107. While not shown in FIG. 1, agricultural harvester 100 may also include one or more actuators that operate to apply a tilt angle, a roll angle, or both to the header 102 or portions of header 102. Tilt refers to an angle at which the cutter 104 engages the crop. The tilt angle is increased, for example, by controlling header 102 to point a distal edge 113 of cutter 104 more toward the ground. The tilt angle is decreased by controlling header 102 to point the distal edge 113 of cutter 104 more away from the ground. The roll angle refers to the orientation of header 102 about the front-to-back longitudinal axis of agricultural harvester 100.

Thresher 110 illustratively includes a threshing rotor 112 and a set of concaves 114. Further, agricultural harvester 100 also includes a separator 116. Agricultural harvester 100 also includes a cleaning subsystem or cleaning shoe (collectively referred to as cleaning subsystem 118) that includes a cleaning fan 120, chaffer 122, and sieve 124. The material handling subsystem 125 also includes discharge beater 126, tailings elevator 128, clean grain elevator 130, as well as unloading auger 134 and spout 136. The clean grain elevator moves clean grain into clean grain tank 132. Agricultural harvester 100 also includes a residue subsystem 138 that can include chopper 140 and spreader 142. Agricultural harvester 100 also includes a propulsion subsystem that includes an engine that drives ground engaging components 144, such as wheels or tracks. In some examples, a combine harvester within the scope of the present disclosure may have more than one of any of the subsystems mentioned above. In some examples, agricultural harvester 100 may have left and right cleaning subsystems, separators, etc., which are not shown in FIG. 1.

In operation, and by way of overview, agricultural harvester 100 illustratively moves through a field in the direction indicated by arrow 147. As agricultural harvester 100 moves, header 102 (and the associated reel 164) engages the crop to be harvested and gathers the crop toward cutter 104. An operator of agricultural harvester 100 can be a local human operator, a remote human operator, or an automated system. An operator command is a command by an operator. The operator of agricultural harvester 100 may determine one or more of a height setting, a tilt angle setting, or a roll angle setting for header 102. For example, the operator inputs a setting or settings to a control system that controls actuator 107. The control system may also receive a setting from the operator for establishing the tilt angle and roll angle of the header 102 and implement the inputted settings by controlling associated actuators, not shown, that operate to change the tilt angle and roll angle of the header 102. The actuator 107 maintains header 102 at a height above ground 111 based on a height setting and, where applicable, at desired tilt and roll angles.

Returning to the description of the operation of agricultural harvester 100, after crops are cut by cutter 104, the severed crop material is moved through a conveyor in feeder house 106 toward feed accelerator 108, which accelerates the crop material into thresher 110. The crop material is threshed by rotor 112 rotating the crop against concaves 114. The threshed crop material is moved by a separator rotor in separator 116 where a portion of the residue is moved by discharge beater 126 toward the residue subsystem 138. The portion of residue transferred to the residue subsystem 138 is chopped by residue chopper 140 and spread on the field by spreader 142. In other configurations, the residue is released from the agricultural harvester 100 in a windrow. In other examples, the residue subsystem 138 can include weed seed eliminators (not shown) such as seed baggers or other seed collectors, or seed crushers or other seed destroyers.

Grain falls to cleaning subsystem 118. Chaffer 122 separates some larger pieces of material from the grain, and sieve 124 separates some of finer pieces of material from the clean grain. Clean grain falls to an auger that moves the grain to an inlet end of clean grain elevator 130, and the clean grain elevator 130 moves the clean grain upwards, depositing the clean grain in clean grain tank 132. Residue is removed from the cleaning subsystem 118 by airflow generated by cleaning fan 120. Cleaning fan 120 directs air along an airflow path upwardly through the sieves and chaffers. The airflow carries residue rearwardly in agricultural harvester 100 toward the residue handling subsystem 138.

Tailings elevator 128 returns tailings to thresher 110 where the tailings are re-threshed. Alternatively, the tailings also may be passed to a separate re-threshing mechanism by a tailings elevator or another transport device where the tailings are re-threshed as well.

FIG. 1 also shows that, in one example, agricultural harvester 100 includes ground speed sensor 146, one or more separator loss sensors 148, a clean grain camera 150, and one or more loss sensors 152 provided in the cleaning subsystem 118.

Ground speed sensor 146 senses the travel speed of agricultural harvester 100 over the ground. Ground speed sensor 146 may sense the travel speed of the agricultural harvester 100 by sensing the speed of rotation of the ground engaging components (such as wheels or tracks), a drive shaft, an axel, or other components. In some instances, the travel speed may be sensed using a positioning system, such as a global positioning system (GPS), a dead reckoning system, a long range navigation (LORAN) system, or a wide variety of other systems or sensors that provide an indication of travel speed.

Loss sensors 152 illustratively provide an output signal indicative of the quantity of grain loss occurring at any point where material may be ejected from agricultural harvester 100, such as in both the right and left sides of the cleaning subsystem 118. In some examples, sensors 152 are strike sensors which count grain strikes per unit of time or per unit of distance traveled to provide an indication of the grain loss occurring at the cleaning subsystem 118. The strike sensors for the right and left sides of the cleaning subsystem 118 may provide individual signals or a combined or aggregated signal. In some examples, sensors 152 may include a single sensor as opposed to separate sensors provided for each cleaning subsystem 118. The sensor configuration can vary still further. For instance, the agricultural harvester 100 may have three of more bays (left, right and middle) with two loss sensors per bay, for a total of six sensors. Other configurations are contemplated herein as well.

Separator loss sensor 148 provides a signal indicative of grain loss in the left and right separators, not separately shown in FIG. 1. The separator loss sensors 148 may be associated with the left and right separators and may provide separate grain loss signals or a combined or aggregate signal.

In some instances, sensing grain loss may also be performed using a wide variety of different types of sensors as well. For instance, the loss sensors may be cameras and image processing systems that capture images of material flow (static or video images) and process the images to identify a quantity of grain loss in the images. The loss sensors can also be deployed in the residue subsystem 138 or elsewhere.

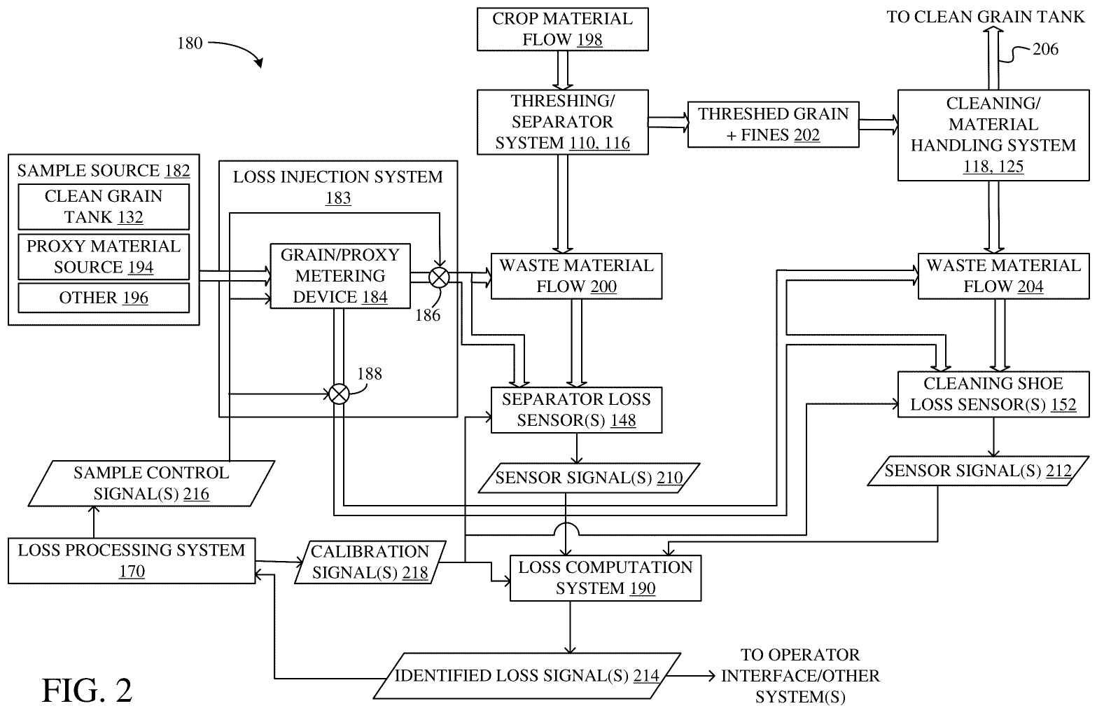

Loss processing system 170 can be mounted to agricultural harvester 100 or to other systems as described elsewhere herein. In one example, loss processing system 170 receives the sensor signals from the loss sensors 148 and 152 and also controls a grain metering device, described elsewhere herein, to intermittently inject a known quantity of loss material into the material flow that is sensed by loss sensors 148 and 152. Loss processing system 170 then monitors the sensor signals to identify a change in the value of the sensor signals induced by the injection of the known quantity of loss. Based upon the response of the loss sensors 148, 152 to the injected loss material, loss processing system 170 can generate calibration outputs to calibrate the loss sensors 148, 152, and/or the algorithms used to generate an output indicative of loss, based upon the loss sensor signals. The operation of loss processing system 170 is described in greater detail below with respect to FIGS. 2-5.

Agricultural harvester 100 may also include other sensors and measurement mechanisms. For instance, agricultural harvester 100 may include one or more of the following sensors: a header height sensor that senses a height of header 102 above ground 111; stability sensors that sense oscillation or bouncing motion (and amplitude) of agricultural harvester 100; a residue setting sensor that is configured to sense whether agricultural harvester 100 is configured to chop the residue, produce a windrow, etc.; a cleaning shoe fan speed sensor to sense the speed of fan 120; a concave clearance sensor that senses clearance between the rotor 112 and concaves 114; a threshing rotor speed sensor that senses a rotor speed of rotor 112; a chaffer clearance sensor that senses the size of openings in chaffer 122; a sieve clearance sensor that senses the size of openings in sieve 124; a material other than grain (MOG) moisture sensor that senses a moisture level of the MOG passing through agricultural harvester 100; one or more machine setting sensors configured to sense various configurable settings of agricultural harvester 100; a machine orientation sensor that senses the orientation of agricultural harvester 100; and crop property sensors that sense a variety of different types of crop properties, such as crop type, crop moisture, and other crop properties. Crop property sensors may also be configured to sense characteristics of the severed crop material as the crop material is being processed by agricultural harvester 100. For example, in some instances, the crop property sensors may sense grain quality such as broken grain, MOG levels; grain constituents such as starches and protein; and grain feed rate as the grain travels through the feeder house 106, clean grain elevator 130, or elsewhere in the agricultural harvester 100. The crop property sensors may also sense the feed rate of biomass through feeder house 106, through the separator 116 or elsewhere in agricultural harvester 100. The crop property sensors may also sense the feed rate as a mass flow rate of grain through elevator 130 or through other portions of the agricultural harvester 100 or provide other output signals indicative of other sensed variables.

FIG. 2 is a block diagram of an agricultural loss calibration architecture or system 180 that shows parts of agricultural harvester 100 (illustrated in FIG. 1) in more detail. Some items in FIG. 2 are similar to those shown in FIG. 1 and they are similarly numbered. Loss calibration architecture 180 also includes sample source 182, loss injection system 183 (which includes grain/proxy metering device 184, metering actuators or valves 186-188), and loss computation system 190. In the example shown in FIG. 2, sample source 182 can include the clean grain tank 192, a proxy material source 194, or other source 196. FIG. 2 also shows that the flow of cop material into threshing/separator systems 110, 116 is represented by block 198 while the waste material flow out of threshing/separator systems 110, 116 is represented by block 200. The flow of threshed grain plus fine material into the cleaning/material handling systems 118, 125 is represented by block 202 while the flow of waste material out of the cleaning/material handling systems 118, 125 is represented by block 204. The flow of material from the cleaning/material handling systems 118, 125 into the clean grain tank is represented by arrow 206.

Before describing the operation of loss calibration architecture 100 in more detail, a description of some of the items in architecture 100, and their operation, will first be provided. As described above with respect to FIG. 1, crop material flow 198 enters the threshing/separator systems 110, 116 and the threshed grain and fine material 202 is provided to the cleaning/material handling systems 118, 125. Separator loss sensors 148 are configured to sense grain loss in the waste material flow 200 exiting the threshing/separator systems 110, 116. Separator loss sensors 148 generate one or more sensor signals 210 which are provided to loss computation system 190. Cleaning shoe loss sensors 152 are configured to sense grain loss in the waste material flow 204 from cleaning/material handling systems 118, 125. Cleaning shoe loss sensors 152 generate a sensor signal 212 indicative of the sensed loss.

Sensor signals 210 and 212 are provided to loss computation system 190 which runs an algorithm based upon the sensor signals 210-212 to generate an identified loss signal 214. The identified loss signal 214 is indicative of the grain loss sensed by separator loss sensors 148 and cleaning shoe loss sensors 152 (and other loss sensors, which may be provided to sense loss in the residue or other material flow). Thus, the identified loss signals 214 can be provided to an operator interface or other system where the identified loss can be shown to the operator or provided to other processing systems or stored elsewhere. The identified loss can be shown as an aggregated loss or as loss per sensor or per system or otherwise.

The identified loss signals 214 (and/or sensor signals 210, 212) can be provided back to loss processing system 170. Loss processing system 170 intermittently generates sample control signals 216 in order to control grain/proxy metering device 184 and valves or actuators 186-188 in order to inject a known amount of material either into waste material flows 200, 204, or directly to sensors 148, 152. The material that is injected may be grain, such as from clean grain tank 132, or another proxy material (such as wood pellets or other pellets or other material that may simulate grain in the material flow or when impacting sensors 148, 152). Grain/proxy metering device 184 may be a metering system such as is found on a planting row unit, a weight or volumetric distribution system found on an air seeder, or other metering device. Therefore, loss processing system 170 can control grain/proxy metering device 184 and valves or actuators 186, 188 to inject a known quantity of source material from a sample source 182 and then process the response from the sensors 148, 152 by monitoring sensor signals 210, 212 and/or identified loss signals 214. Based on the response of the sensors 148, 152 and loss computation system 190 to the injected material, loss processing system 170 generates calibration signals 218 that can be used to calibrate the sensors 148, 152 and/or the algorithm used by loss computation system 190 to generate the identified loss signals 214.

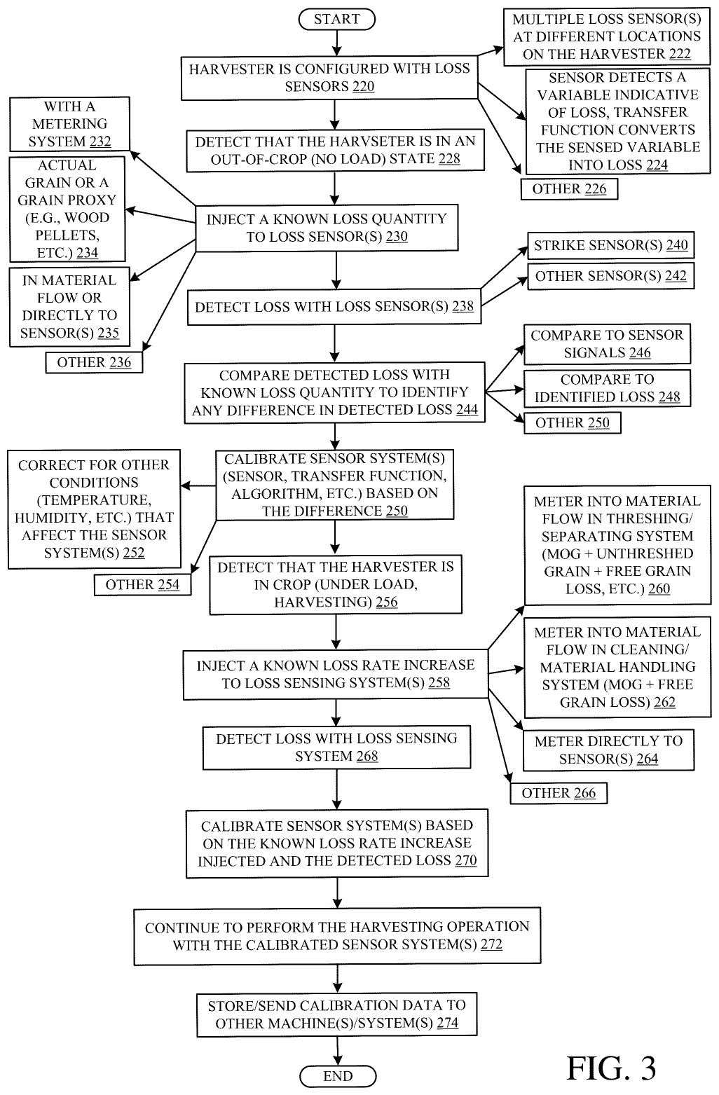

FIG. 3 is a flow diagram illustrating one example of the operation of loss calibration architecture 180 in more detail. It is first assumed that the harvester 100 is configured with loss sensors, as indicated by block 220 in the flow diagram of FIG. 3. In one example, there are multiple loss sensors at different locations on the harvester, as indicated by block 222. The loss sensors detect a variable (such as grain strikes or another variable) indicative of loss and a location computation system 190 includes a transfer function or other logic or algorithm that converts the sensed variable into identified loss signals 214, as indicated by block 224 in the flow diagram of FIG. 3. The harvester and sensing systems can be figured in other ways as well, as indicated by block 226.

Loss processing system 170 may be configured to first obtain a baseline value indicative of how the loss sensors 148, 152 and loss computation system 190 are functioning. That baseline value may be taken, for example, when harvester 100 is not harvesting any crop. Loss processing system 170 thus first detects that the harvester 102 is in an out-of-crop (or in a no-load state), as indicated by block 228.

When in the no-load state, loss processing system 170 controls grain/proxy metering device 184 and valves or actuators 186 and 188 to inject a known loss quantity to the loss sensing systems on harvester 100. Injecting a known loss quantity is indicated by block 230 in the flow diagram of FIG. 3. Using a metering device 184 to inject the known loss quantity is indicated by block 232. The known loss quantity can be from a variety of different sample sources 182, such as the clean grain tank 132, or a proxy (e.g., wood pellets, etc.) or another source, as indicated by block 234 in the flow diagram of FIG. 3. The known loss quantity can be injected in the material flow upstream of the sensors 148, 152, or directly to the sensors 148, 152, as indicated by block 235. The known loss quantity can be injected in other ways as well, as indicated by block 236.

The sensors 148, 152 then detect loss, as indicated by block 238 in the flow diagram of FIG. 3. As discussed above, the sensors can be strike sensors 240, or other sensors, such as image capture devices with image processing systems, or other sensors, as indicated by block 242.

Loss processing system 170 then compares the detected loss with the known loss quantity that was injected into the loss sensing systems in order to identify any difference in the detected loss, based upon the response of the loss sensors 148, 152. Comparing the detected loss with the known loss quantity is indicated by block 244 in the flow diagram of FIG. 3.

In one example, loss processing system 170 compares the known loss quantity to the sensor signals 210, 212 generated by sensors 148, 152, as indicated by block 246 in the flow diagram of FIG. 3. In another example, loss processing system 170 compares the known loss quantity to the identified loss signals 214 generated by the loss computation system 190, as indicated by block 248 in the flow diagram of FIG. 3. The comparison can be made in other ways as well, as indicated by block 250.

Based on the comparison, loss processing system 170 now has baseline information to identify how the sensor systems (e.g., sensors 148, 152 and loss computation system 190) reacted to the known injected loss quantity and can calibrate the sensor system (the sensors 148, 152 themselves, the transfer function, any other algorithms run by loss computation system 190) based upon the difference between the detected loss and the known loss quantity that was injected into the sensors systems. Generating calibration signals 218 to calibrate the sensor systems is indicated by block 250 in the flow diagram of FIG. 3. Also, in one example, loss processing system 170 can generate calibration signals 218 to compensate or correct the sensor systems for other conditions, such as environmental conditions (temperature, humidity, etc.) or other conditions that affect the sensor systems. Correcting for such conditions is indicated by block 252 in the flow diagram of FIG. 3. Calibrating the sensor systems based upon the baseline information can be performed in other ways as well, as indicated by block 254.

After performing the baseline correction and calibration, loss processing system 170 can continue to calibrate the loss sensing systems during harvesting. Loss processing system 170 thus detects that harvester 100 is in crop and harvesting, or under load. Detecting that the harvester is harvesting is indicated by block 256 in the flow diagram of FIG. 3.

Loss processing system 170 can then generate sample control signals 216 to intermittently inject a known loss rate increase to the loss sensing systems on harvester 100. Injecting a known loss rate increase is indicated by block 258 in the flow diagram of FIG. 3. For instance, loss processing system 170 can generate sample control signals 216 to control grain/proxy metering device 184 to meter a known quantity of loss material into the waste material flow 200 from threshing/separator systems 110, 116, where the waste material flow 200 includes material other than grain (MOG) plus unthreshed grain and free loss, etc. Injecting the known quantity of loss material (e.g., a known loss rate increase) into material flow 200 is indicated by block 260 in the flow diagram of FIG. 3. Loss processing system 170 can also generate sample control signals 216 to control grain/proxy metering device 184 and valve or actuator 188 to inject a known loss rate increase into the waste material flow 204 form the cleaning/material handling subsystems 118, 125 as indicated by block 262 in the flow diagram of FIG. 3. In another example, loss processing system 170 can generate sample control signals 216 to meter the known loss rate increase directly to the sensors 148, 152, as indicated by block 264 in the flow diagram of FIG. 3. The known loss rate increase can be injected to the loss sensing systems in other ways as well, as indicated by block 266.

The loss sensors 148, 152 then detect loss and provide sensor signals 210, 212 to loss computation system 190 which computes the identified loss based upon the sensor signals 210, 212 and generates an output signal 214 indicative of the identified loss. Detecting loss with the loss sensing systems is indicated by block 268 in the flow diagram of FIG. 3.

The sensor signals 210, 212 and/or the identified loss signals 214 are provided to loss processing system 170 which compares the response of the loss sensing systems to the injected loss rate increase in order to generate calibration signals 218. The calibration signals 218 can be provided to calibrate the loss sensors 148, 152 and/or to calibrate the loss computation system 190 (e.g., to calibrate the models or algorithms run by system 190). Calibrating the sensor systems based upon the known loss rate increase injected into the loss sensing systems and the detected loss is indicated by block 270 in the flow diagram of FIG. 3.

Harvester 100 then continues to perform the harvesting operation with the calibrated sensor systems, as indicated by block 272 in the flow diagram of FIG. 3. The calibration data can be stored or sent to other machines or other systems, as indicated by block 274 in the flow diagram of FIG. 3.

It will also be noted that, as discussed in greater detail below, loss processing system 170 can intermittently perform calibration during the operation of harvester 100. The calibration can be performed by injecting various different known loss amounts to the sensor systems, or in other ways.

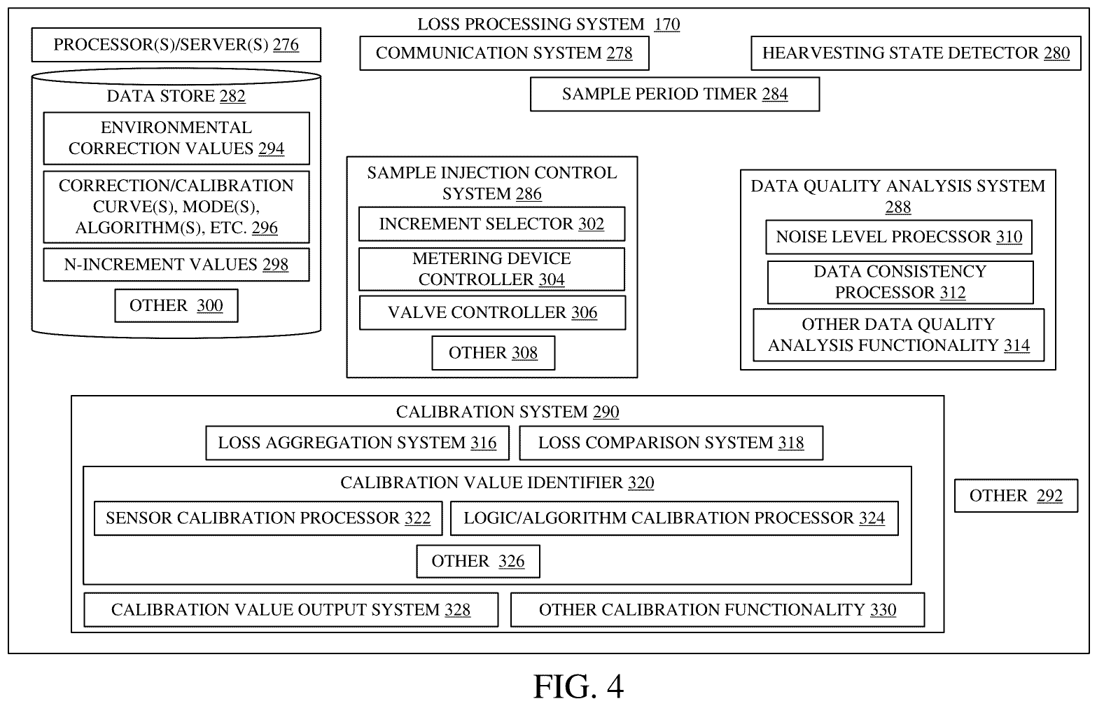

FIG. 4 is a block diagram showing one example of loss processing system 170 in more detail. In the example shown in FIG. 4, loss processing system 170 includes one or more processors or servers 276, communication system 278, harvesting state detector 280, data store 282, sample period timer 284, sample injection control system 286, data quality analysis system 288, calibration system 290, and other items 292. Data store 282 can include environmental correction values 294, correction/calibration curves, models, algorithms, etc. 296, N-increment values 298, and other items 300. Sample injection control system 286 can include increment selector 302, metering device controller 304, valve controller 306, and other items 308. Data quality analysis system 288 includes noise level processor 310, data consistency processor 312, and other data quality analysis functionality 314. Calibration system 290 can include loss aggregation system 316, loss comparison system 318, calibration value identifier 320 (which can include sensor calibration processor 322, logic/algorithm calibration processor 324, and other items 326), calibration value output system 328, and other calibration functionality 330. Before describing loss processing system 170 in more detail, a description of some of the items in loss processing system 170, and their operation, will first be provided.

Environmental correction values 294 may be values that are used to correct the loss sensors or loss computation system based upon environmental factors. For instance, the sensors 148, 152 or system 190 may perform differently under different humidity or temperature conditions, or under other environmental conditions. The difference in performance may be captured by environmental correction values 294 which are used to correct the sensor settings, or the variables being used in the algorithm run by loss computation system 190, or to make other corrections.

Correction/calibration curves, models, algorithms, etc. 296 may be used to perform the processing that is used by calibration system 290 in order to generate calibration signals 218 to calibrate loss sensors 148, 152, loss computation system 190, or other items. For instance, correction/calibration curves, models, algorithms, etc. 296 may include an optimization algorithm that is run based upon the values obtained by loss processing system 170 in order to identify, as calibration data, sensor settings, transfer function values, etc.

N-increment values 298 may be predefined or default values that are used to identify the amount of grain or proxy material to be injected during a calibration process. In one example, the N-increment values are N separate values that can be injected during a calibration operation performed over a plurality of different sample time periods, as discussed in greater detail below.

Communication system 278 may facilitate the communication of items in loss processing system 170 and loss calibration architecture 180 with one another, and with other items. Therefore, communication system 278 may be a controller area network (CAN) bus and bus controller and/or any other communication systems that are used to communicate over a wide area network, a local area network, a cellular communication network, a near field communication network, a Wi-Fi or Bluetooth network, or other networks or combinations of networks.

Harvesting state detector 280 detects whether harvester 100 is in-crop and harvesting or is out-of-crop and not harvesting. In one example, harvesting state detector 280 detects whether crop material is flowing through one or more different regions of harvester 100 to detect whether harvester 100 is harvesting. In another example, harvesting state detector 280 can detect whether header 102 is engaging crop, or is operational, or other characteristics of header 102 to determine whether harvester 100 is harvesting. In yet another example, harvesting state detector 280 can detect presence or flow of crop material through harvester 100, or whether other harvesting functionality is operating in order to determine whether the harvester is in-crop and harvesting. Harvesting state detector 280 can also detect the location of harvester 100 and access coverage information (such as in a coverage map) to determine whether harvester 100 is in an area of unharvested crop or in an area where crop has already been harvested. Harvesting state detector 280 can detect the state of harvester 100 (e.g., whether harvester 100 is harvesting crop or not) in other ways as well.

Sample period timer 284 may be a timing circuit or logic that sets and times a sample period. For instance, it may be that loss processing system 170 continues to inject a known quantity of loss into the loss sensing systems on harvester 100 for a sample period and then stops injecting the loss for another sample period, and aggregates the loss detected over those two time periods in order to determine whether calibration is needed. In such a scenario, sample period timer can be programmed with a sample period, or the sample period can be a default period, a period set by the operator, or another period. Sample period timer 284 is used to generate a signal indicative of when the sample period begins and when it ends.

Sample injection control system 286 controls the injection of grain/proxy material by controlling grain/proxy metering device 184 and/or valves or actuators 186-188. Increment selector 302 determines how much material is to be injected into the loss sensing systems to perform calibration. In one example, increment selector 302 accesses the N-increment values 298 in data store 282 to identify the amount of material that is to be injected into the sensing systems. Increment selector 302 may identify the amount to be injected in other ways as well.

Metering device controller 304 generates control signals 216 to control grain/proxy metering device 184 in order to inject the desired increment of material into the loss sensing systems. For instance, metering device 184 may be controllable to inject a desired quantity (volume, weight, etc.) of material from one of the sample sources 182 based on time, based on speed, or using other control criteria. Metering device controller 304 generates a control signal to meter out the selected increment of increased loss (selected by increment selector 302) into the loss sensing systems to perform calibration. Valve controller 306 controls valves or actuators 186, 188 to determine where the material is injected (e.g., into one or more of the waste material flows 200, 204, or directly to sensors 148, 152, or elsewhere). Valve controller 306 may control the various valves 186, 188 independently, sequentially, or simultaneously to inject a known quantity of loss into multiple material flows or sensors at the same time.

Data quality analysis system 288 analyzes the data retrieved during the sample periods to determine whether the data is of sufficient quality that it should be used for calibration. For instance, the data may be so noisy or inconsistent that the data should not be used to calibrate the loss sensing systems. Noise level processor 310 thus detects the noise level in the data (such as by detecting how widely the data varies over a given time period, or other criteria indicative of noise). Data consistency processor 312 can process the data to determine whether it varies in a consistent way, or in an expected way based upon a model, an algorithm, or using other mechanisms. Other data quality analysis functionality 314 can perform other operations to identify the quality of the data in other ways. Based upon the noise level in the data, the consistency of the data, and/or any other criteria, data quality analysis system 288 provides an output to calibration system 290 indicating whether calibration system 290 should perform calibration based upon the collected data, or whether the data is of insufficient quality (e.g., the noise level is too high, the data is unexpectedly inconsistent, etc.) so that calibration should not be performed based upon that data.

In calibration system 290, loss aggregation system 316 aggregates the loss values output (e.g., by sensor signals 210, 212, or as identified loss signals 214, or both) over the sample periods timed by sample period timer 284. Loss comparison system 318 compares the aggregated loss against the known loss value injected into the sensor systems during the sample time periods. Based upon the comparison, loss comparison system 318 generates an output indicative of how the sensor systems responded to the injected increase in loss. Calibration value identifier 320 identifies calibration values that can be output as calibration signals 218 to calibrate the sensors themselves 148, 152, and/or loss computation system 190. Sensor calibration processor 322 generates outputs indicative of sensor settings or other calibration values that can be used to calibrate the sensors 148, 152 themselves. Logic/algorithm calibration processor 324 generates outputs that can be used to calibrate the transfer function or other algorithm or prediction model run by loss computation system 190 to generate the identified loss signals 214 indicative of the sensed loss.

Calibration value output system 328 generates an output indicative of the calibration values. The output may be in the form of calibration signals 218 that can be applied to configure sensors 148, 152 based upon the calibration values and/or to configure the transfer function or other algorithm or model used by loss computation system 190 based upon the calibration values.

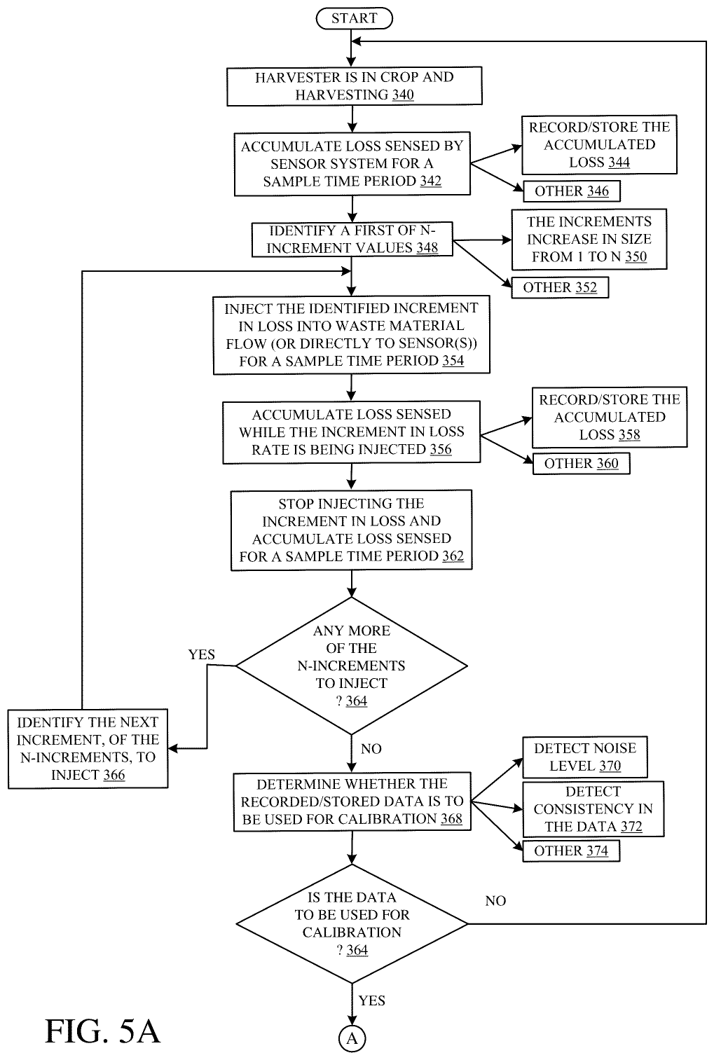

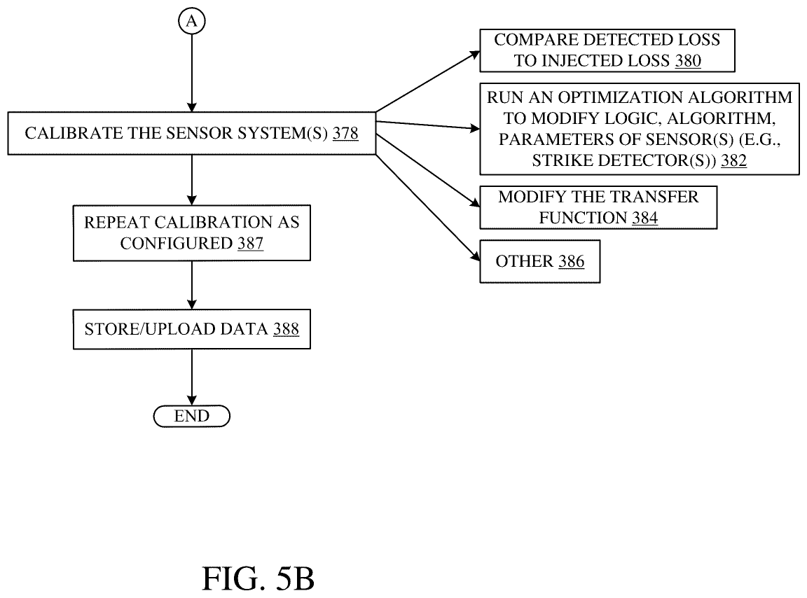

FIGS. 5A and 5B (collectively referred to herein as FIG. 5) show one example of a flow diagram that illustrates the operation of loss processing system 170 in more detail.

It will be assumed for the sake of discussing FIG. 5 that loss processing system 170 has already generated the baseline value discussed above with respect to FIG. 3 when harvester was out of crop and not harvesting. Therefore, for purposes of the present description, it will be assumed that harvesting state detector 280 detects that harvester 100 is in-crop and harvesting crop material, as indicated by block 340 in the flow diagram of FIG. 5.

Also, it will be appreciated that loss processing system 170 can inject a known loss value into multiple sensor systems at the same time, or that the operations can be performed for individual sensing systems. For the sake of the present description, it will be assumed that loss processing system 170 is attempting to calibrate a single sensing system (e.g., loss sensors 148 and loss computation system 190). Therefore, prior to injecting loss, loss aggregation system 316 accumulates or aggregates the loss sensed by the loss sensing system (sensor 148 and system 190) for a sample time period that is timed by sample period timer 284. Accumulating the loss sensed by a loss sensor system for a sample time period is indicated by block 342 in the flow diagram of FIG. 5. Loss aggregation system 316 may aggregate the loss indicated by sensor signals 210 and/or identified loss signals 214 for the sample time period. The aggregated loss can be recorded and stored as indicated by block 344 or the loss can be accumulated in other ways as indicated by block 346.

Next, increment selector 302 selects an increment value 298 which identifies a known amount of loss material that will be injected either into material flow 200 or directly to sensors 148. Identifying the first of the N-increment values is indicated by block 348 in the flow diagram of FIG. 5. In one example, the N-increment values 298 identify increments that increase in size from the first value to the Nth value as indicated by block 350. The increments can have other values as well, as indicated by block 352.

Metering device controller 304 and valve controller 306 then control grain/proxy metering device 184 and valve 186 to inject the identified increment in loss material into the waste material flow 200 (or directly to the sensors 148) for the sample time period that is timed by sample period timer 284. Injecting the identified increment in loss is indicated by block 354 in the flow diagram of FIG. 5.

While the loss increment is being injected into the sensing system, loss aggregation system 316 accumulates the sensed loss, as indicated by block 356 in the flow diagram of FIG. 5. Again, the accumulated loss can be recorded or stored, as indicated by block 358, or accumulated in other ways, as indicated by block 360.

After the sample period has timed out (as signaled by sample period timer 284), metering device controller 304 and valve controller 306 generate control signals to stop injecting the increment in loss material and to again accumulate loss sensed for another time period (without any additional loss being injected into the loss sensing system). Stopping the injection of additional loss, and continuing to sense and accumulate loss over a sample time period is indicated by block 362 in the flow diagram of FIG. 5.

In one example, loss processing system 170 continues this pattern (of injecting an incremental value of loss for a sample time period while aggregating the loss) and then simply aggregating the loss with no additional loss injected, repeatedly for the N different increment values in loss 298. Therefore, at block 364 in FIG. 5, increment selector 302 determines whether there are any more of the N-increment values 298 that are to be injected into the loss sensing system to perform calibration. If there are more of the N-increments to inject, then increment selector 302 selects the next increment to inject, as indicated by block 366, and processing reverts to block 354 where that increment is injected into the sensing system. It will be noted that the sample time periods can all be the same through a calibration operation, or the sample time periods can be different. The sample time periods can also be static or vary.

If, at block 364, it is determined that there are no more of the N-increment values to inject into the loss sensing system, then data quality analysis system 288 determines whether the recorded or stored loss data can be used for calibration, as indicated by block 368 in the flow diagram of FIG. 5. In one example, noise level processor 310 detects the noise level as indicated by block 370, and/or data consistency processor 312 detects the consistency in the data as indicated by block 372. Any of a wide variety of other quality criteria can be analyzed to determine whether the aggregated loss data should be used to perform calibration, as indicated by block 374. If the data is not to be used for calibration, as determined by block 376, then processing reverts to block 340 where the calibration process can be intermittently repeated. However, if, at block 376 it is determined that the aggregated loss data can be used to perform calibration, then calibration system 290 calibrates the loss sensor system based upon the aggregated loss. Calibrating the loss sensor system is indicated by block 378 in the flow diagram of FIG. 5.

For instance, loss comparison system 318 can compare the detected loss to the injected loss, as indicated by block 380, and calibration value identifier 320 can run an optimization algorithm to modify the settings, logic, algorithm, or other parameters of the sensors (e.g., strike sensors 148) to calibrate the strike sensors based upon the comparison. Running the optimization algorithm to modify the settings, logic, algorithm, or parameters corresponding to sensors 148 is indicated by block 382 in the flow diagram of FIG. 5. Logic/algorithm calibration processor 324 can also generate control signals to modify the transfer function or other algorithm or model run by loss computation system 190 to generate the identified loss signals 214 based on the calibration data. Modifying the transfer function based on the calibration data is indicated by block 384 in the flow diagram of FIG. 5. Calibrating the loss sensor system can be performed in other ways as well, as indicated by block 386. The calibration operation can be repeated as often as configured to do so, such as based on time criteria (e.g., periodically) or based on other criteria (such as based on a change in location, sensed crop or terrain conditions, or other criteria) as indicated by block 387. The calibration data can also be stored and/or uploaded to other systems, other machines, etc., as indicated by block 388.

It can thus be seen that the present description describes a system for calibrating loss sensors on a harvester. The system injects a known quantity of loss material into the material stream processed by the loss sensing system or directly to the loss sensors. The response of the loss sensing system to the injected loss material is used to determine whether calibration is to be performed and, if so, to generate calibration values to calibrate the sensors themselves and/or the transfer function or other algorithm used to output a loss value based upon the sensor signals. This greatly reduces the time and complexity in calibrating the loss sensing systems and also greatly increases the accuracy of the loss sensing systems especially in varying field conditions or varying environmental conditions.

The present discussion has mentioned processors and servers. In one example, the processors and servers include computer processors with associated memory and timing circuitry, not separately shown. The processors or servers are functional parts of the systems or devices to which they belong and are activated by, and facilitate the functionality of the other components or items in those systems.

Also, a number of user interface (UI) displays have been discussed. The UI displays can take a wide variety of different forms and can have a wide variety of different user actuatable input mechanisms disposed thereon. For instance, the user actuatable input mechanisms can be text boxes, check boxes, icons, links, drop-down menus, search boxes, etc. The mechanisms can also be actuated in a wide variety of different ways. For instance, the mechanisms can be actuated using a point and click device (such as a track ball or mouse). The mechanisms can be actuated using hardware buttons, switches, a joystick or keyboard, thumb switches or thumb pads, etc. The mechanisms can also be actuated using a virtual keyboard or other virtual actuators. In addition, where the screen on which the mechanisms are displayed is a touch sensitive screen, the mechanisms can be actuated using touch gestures. Also, where the device that displays the mechanisms has speech recognition components, the mechanisms can be actuated using speech commands.

A number of data stores have also been discussed. It will be noted the data stores can each be broken into multiple data stores. All can be local to the systems accessing the data stores, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

It will be noted that the above discussion has described a variety of different systems, components, generators, selectors, detectors, and/or logic. It will be appreciated that such systems, components, generators, selectors, detectors, and/or logic can be comprised of hardware items (such as processors and associated memory, or other processing components, some of which are described below) that perform the functions associated with those systems, components, generators, and/or logic. In addition, the systems, components, generators, selectors, detectors, and/or logic can be comprised of software that is loaded into a memory and is subsequently executed by a processor or server, or other computing component, as described below. The systems, components, generators, selectors, detectors, and/or logic can also be comprised of different combinations of hardware, software, firmware, etc., some examples of which are described below. These are only some examples of different structures that can be used to form the systems, components, generators, selectors, detectors, and/or logic described above. Other structures can be used as well.

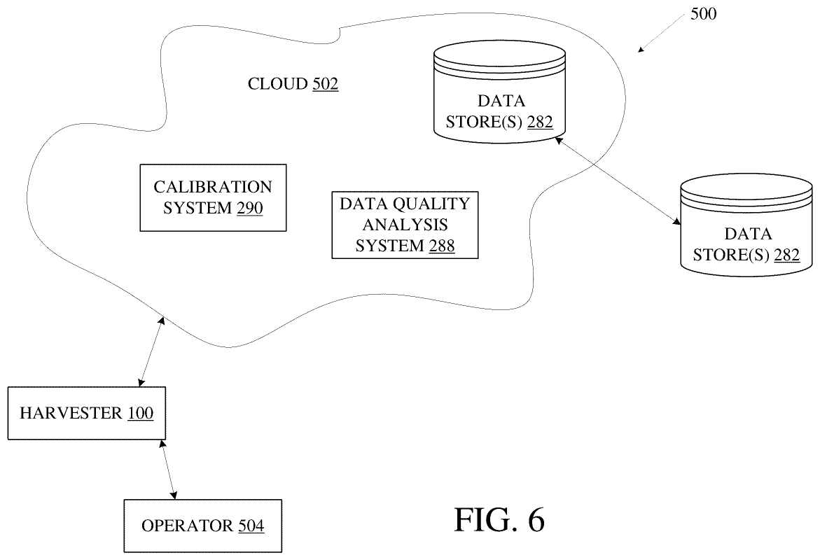

FIG. 6 is a block diagram of harvester 100, shown in FIG. 1, except that harvester 100 has an operator 504 and communicates with elements in a remote server architecture 500. In an example, remote server architecture 500 can provide computation, software, data access, and storage services that do not require end-user knowledge of the physical location or configuration of the system that delivers the services. In various examples, remote servers can deliver the services over a wide area network, such as the internet, using appropriate protocols. For instance, remote servers can deliver applications over a wide area network and they can be accessed through a web browser or any other computing component. Software or components shown in previous FIGS. as well as the corresponding data, can be stored on servers at a remote location. The computing resources in a remote server environment can be consolidated at a remote data center location or they can be dispersed. Remote server infrastructures can deliver services through shared data centers, even though they appear as a single point of access for the user. Thus, the components and functions described herein can be provided from a remote server at a remote location using a remote server architecture. Alternatively, the components and functions can be provided from a conventional server, or they can be installed on client devices directly, or in other ways.

In the example shown in FIG. 6, some items are similar to those shown in previous FIGS. and they are similarly numbered. FIG. 6 specifically shows that calibration system 290 and data store 282 can be located at a remote server location 502. Therefore, harvester 100 accesses those systems through remote server location 502.

FIG. 6 also depicts another example of a remote server architecture. FIG. 6 shows that it is also contemplated that some elements of previous FIGS are disposed at remote server location 502 while others are not. By way of example, data store 282 or data quality analysis system 288, or other systems can be disposed at a location separate from location 502, and accessed through the remote server at location 502. Regardless of where the items are located, the items can be accessed directly by harvester 100, through a network (either a wide area network or a local area network), the items can be hosted at a remote site by a service, or the items can be provided as a service, or accessed by a connection service that resides in a remote location. Also, the data can be stored in substantially any location and intermittently accessed by, or forwarded to, interested parties. All of these architectures are contemplated herein.

It will also be noted that the elements of previous FIGS., or portions of them, can be disposed on a wide variety of different devices. Some of those devices include servers, desktop computers, laptop computers, tablet computers, or other mobile devices, such as palm top computers, cell phones, smart phones, multimedia players, personal digital assistants, etc.

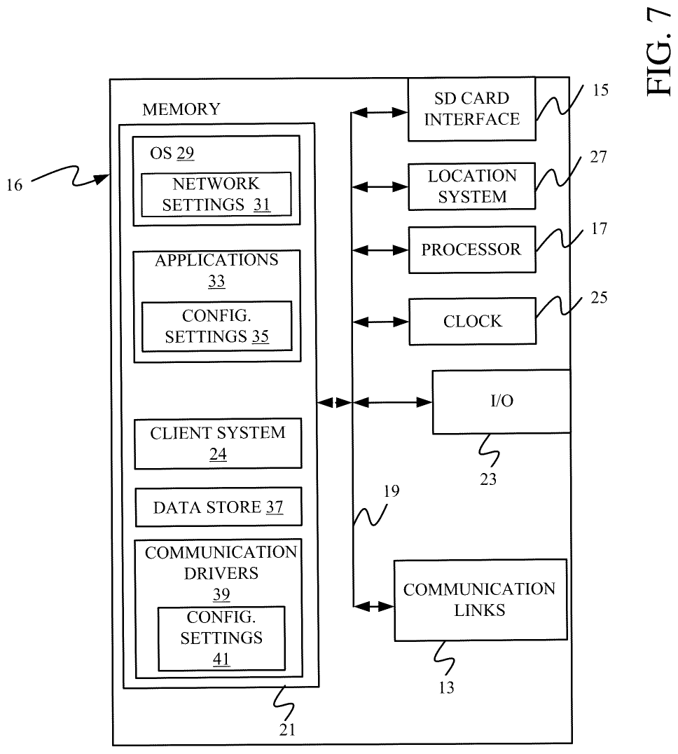

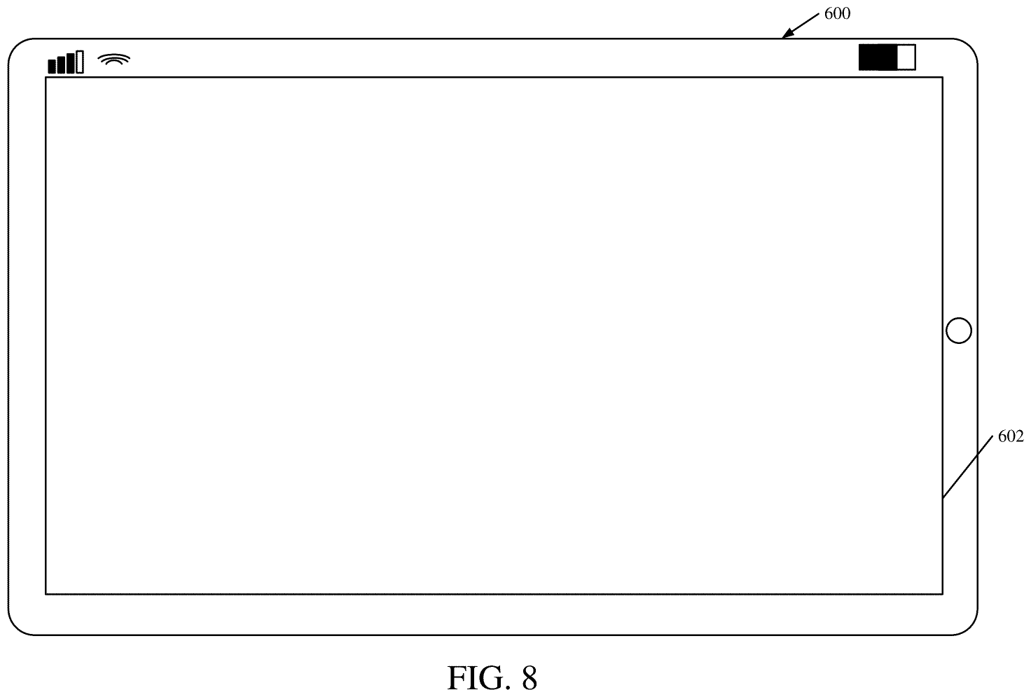

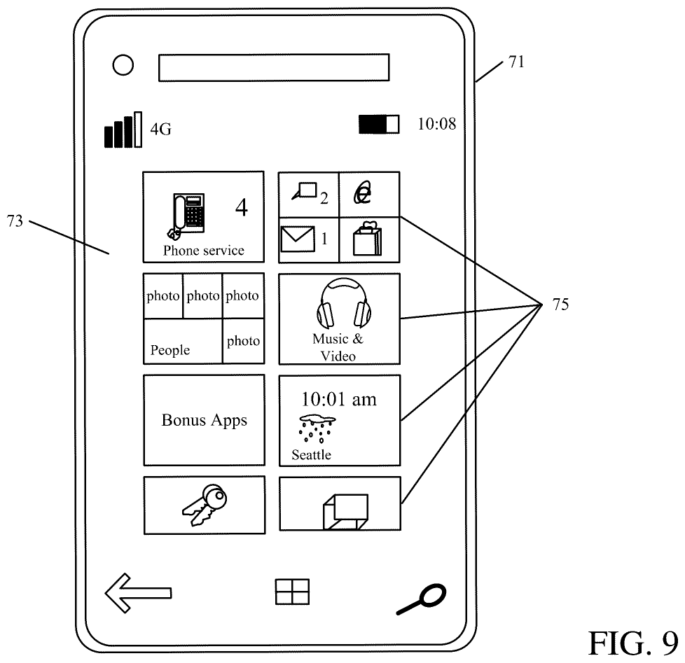

FIG. 7 is a simplified block diagram of one illustrative example of a handheld or mobile computing device that can be used as a user's or client's hand held device 16, in which the present system (or parts of it) can be deployed. For instance, a mobile device can be deployed in the operator compartment of harvester 100 for use in generating, processing, or displaying the loss data. FIGS. 8-9 are examples of handheld or mobile devices.

FIG. 7 provides a general block diagram of the components of a client device 16 that can run some components shown in previous FIGS., that interacts with them, or both. In the device 16, a communications link 13 is provided that allows the handheld device to communicate with other computing devices and under some examples provides a channel for receiving information automatically, such as by scanning. Examples of communications link 13 include allowing communication though one or more communication protocols, such as wireless services used to provide cellular access to a network, as well as protocols that provide local wireless connections to networks.

In other examples, applications can be received on a removable Secure Digital (SD) card that is connected to an interface 15. Interface 15 and communication links 13 communicate with a processor 17 (which can also embody processors or servers from previous FIGS.) along a bus 19 that is also connected to memory 21 and input/output (I/O) components 23, as well as clock 25 and location system 27.

I/O components 23, in one example, are provided to facilitate input and output operations. I/O components 23 for various examples of the device 16 can include input components such as buttons, touch sensors, optical sensors, microphones, touch screens, proximity sensors, accelerometers, orientation sensors and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a dead reckoning system, a cellular triangulation system, or other positioning system. Location system 27 can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. Memory 21 can also include computer storage media (described below). Memory 21 stores computer readable instructions that, when executed by processor 17, cause the processor to perform computer-implemented steps or functions according to the instructions. Processor 17 can be activated by other components to facilitate their functionality as well.

FIG. 8 shows one example in which device 16 is a tablet computer 600. In FIG. 8, computer 600 is shown with user interface display screen 602. Screen 602 can be a touch screen or a pen-enabled interface that receives inputs from a pen or stylus. Computer 600 can also use an on-screen virtual keyboard. Of course, computer 600 might also be attached to a keyboard or other user input device through a suitable attachment mechanism, such as a wireless link or USB port, for instance. Computer 600 can also illustratively receive voice inputs as well.

FIG. 9 shows that the device can be a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

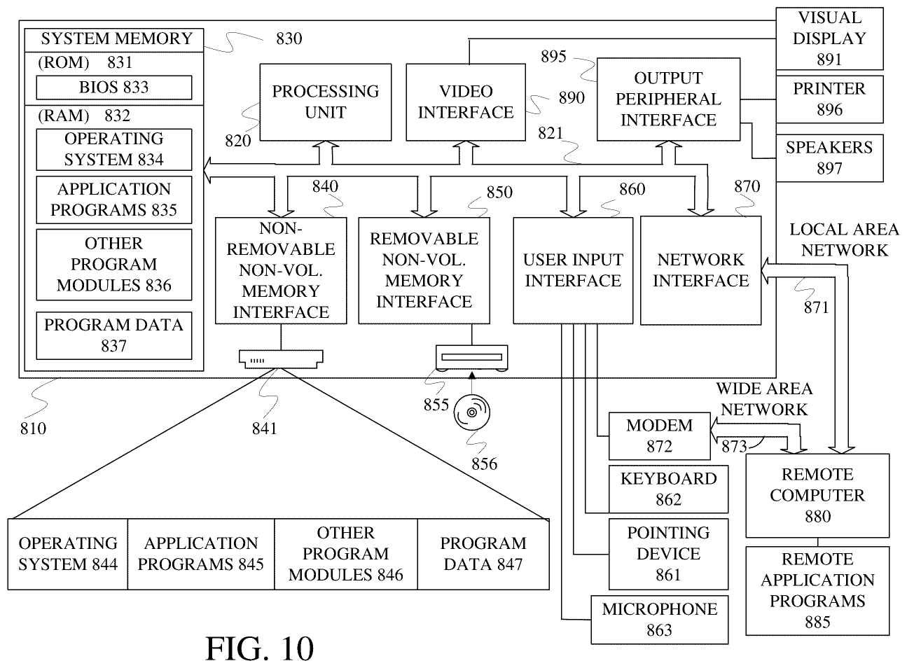

FIG. 10 is one example of a computing environment in which elements of previous FIGS., or parts of it, (for example) can be deployed. With reference to FIG. 10, an example system for implementing some embodiments includes a computing device in the form of a computer 810 programmed to operate as described above. Components of computer 810 may include, but are not limited to, a processing unit 820 (which can comprise processors or servers from previous FIGS.), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. Memory and programs described with respect to previous FIGS. can be deployed in corresponding portions of FIG. 10.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. Computer storage media includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media may embody computer readable instructions, data structures, program modules or other data in a transport mechanism and includes any information delivery media. The term “modulated data signal” means a signal that has one or more of its characteristics set or changed in such a manner as to encode information in the signal.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 10 illustrates operating system 834, application programs 835, other program modules 836, and program data 837.

The computer 810 may also include other removable/non-removable volatile/nonvolatile computer storage media. By way of example only, FIG. 10 illustrates a hard disk drive 841 that reads from or writes to non-removable, nonvolatile magnetic media, an optical disk drive 855, and nonvolatile optical disk 856. The hard disk drive 841 is typically connected to the system bus 821 through a non-removable memory interface such as interface 840, and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (e.g., ASICs), Application-specific Standard Products (e.g., ASSPs), System-on-a-chip systems (SOCs), Complex Programmable Logic Devices (CPLDs), etc.

The drives and their associated computer storage media discussed above and illustrated in FIG. 10, provide storage of computer readable instructions, data structures, program modules and other data for the computer 810. In FIG. 10, for example, hard disk drive 841 is illustrated as storing operating system 844, application programs 845, other program modules 846, and program data 847. Note that these components can either be the same as or different from operating system 834, application programs 835, other program modules 836, and program data 837.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit through a user input interface 860 that is coupled to the system bus, but may be connected by other interface and bus structures. A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections (such as a controller area network-CAN, local area network-LAN, or wide area network WAN) to one or more remote computers, such as a remote computer 880.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. In a networked environment, program modules may be stored in a remote memory storage device. FIG. 10 illustrates, for example, that remote application programs 885 can reside on remote computer 880.

It should also be noted that the different examples described herein can be combined in different ways. That is, parts of one or more examples can be combined with parts of one or more other examples. All of this is contemplated herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer implemented method, comprising:
controlling a loss injection system to inject a quantity of material into a loss sensing system on an agricultural harvester;
sensing loss with the loss sensing system;
generating a loss signal indicative of the sensed loss;
generating a calibration value based on the injected quantity of loss material and the sensed loss; and
generating a control signal to configure the loss sensing system based on the calibration value.

2. The computer implemented method of claim 1 wherein the loss sensing system comprises a loss sensor that generates a loss sensor signal and a loss computation system that generates an identified loss signal based on the loss sensor signal and wherein controlling the loss injection system comprises:
controlling the loss injection system to inject the quantity of material into a material flow sensed by the loss sensor.

3. The computer implemented method of claim 1 wherein the loss sensing system comprises a loss sensor configured to generate a loss sensor signal and a loss computation system configured to generate an identified loss signal based on the loss sensor signal and wherein controlling the loss injection system comprises:
controlling the loss injection system to inject the quantity of material to the loss sensor.

4. The computer implemented method of claim 1 wherein the loss sensing system comprises a loss sensor that generates a loss sensor signal and a loss computation system that generates an identified loss signal based on the loss sensor signal and wherein controlling a loss injection system comprises:
controlling the loss injection system to inject the known quantity of material for a first sample time period; and
controlling the loss injection system to stop injecting material for a second sample time period.

5. The computer implemented method of claim 4 wherein controlling the loss injection system to inject a known quantity of material comprises:
selecting a known quantity of material; and
controlling the loss injection system to inject the selected known quantity of material.

6. The computer implemented method of claim 5 wherein controlling the loss injection system to inject a known quantity of material comprises:
repeating, for a calibration process, steps of:
selecting a known quantity of material;
controlling the loss injection system to inject the selected known quantity of loss material; and
controlling the loss injection system to stop injecting the loss material for the second sample time period.

7. The computer implemented method of claim 6 wherein selecting a known quantity of material comprises:
selecting a known value of material that changes with each repetition during the calibration process.

8. The computer implemented method of claim 4 wherein generating a calibration value comprises:
aggregating the sensed loss during the first sample time period;
aggregating the sensed loss during the second sample time period; and
generating the calibration value based on the aggregated loss and the known quantity of injected material.

9. The computer implemented method of claim 8 wherein generating the calibration value comprises:
comparing the aggregated sensed loss during the first sample time period with the known quantity of material to obtain a comparison result; and
generating the calibration value based on the comparison result.

10. The computer implemented method of claim 1 wherein generating a calibration value further comprises:
detecting whether the agricultural harvester is harvesting;
generating a harvester state value based on whether the agricultural harvester is harvesting; and
generating the calibration signal based on the harvester state value.

11. The computer implemented method of claim 4 wherein generating a control signal to configure the loss sensing system based on the calibration value comprises:
generating a sensor calibration signal to configure the loss sensor based on the calibration value.

12. The computer implemented method of claim 4 wherein generating a control signal to configure the loss sensing system based on the calibration value comprises:
generating a computation system calibration signal to configure the loss computation system based on the calibration value.

13. The computer implemented method of claim 4 wherein the first and second sample time periods have a same length.

14. An agricultural system, comprising:
a loss sensing system configured to sense crop loss on an agricultural harvester and generate a loss signal indicative of the sensed crop loss;
a loss injection system configured to inject material into the loss sensing system; and
a loss processing system configured to control the loss injection system to inject a known quantity of material into the loss sensing system, generate a calibration value based on the injected known quantity of material and the sensed crop loss, and generate a control signal to configure the loss sensing system based on the calibration value.

15. The agricultural system of claim 14 wherein the loss sensing system comprises:
a loss sensor configured to generate a loss sensor signal; and
a loss computation system configured to generate an identified loss signal based on the loss sensor signal and wherein the loss processing system is configured to control the loss injection system to inject the known quantity of material into a material flow sensed by the loss sensor.

16. The agricultural system of claim 15 wherein the loss processing system comprises:
a sample injection control system configured to control the loss injection system to inject a known quantity of material for a first sample time period and to control the loss injection system to stop injecting material for a second sample time period.

17. The agricultural system of claim 16 wherein the sample injection system comprises:
A value an increment selector configured to select a known quantity of material; and
a metering device controller configured to control the loss injection system to inject the selected known quantity of loss material.

18. The agricultural system of claim 15 wherein the loss processing system comprises:
a sensor calibration processor configured to generate a sensor calibration signal to configure the loss sensor based on the calibration value.

19. The agricultural system of claim 15 wherein the loss processing system comprises:
a logic/algorithm calibration processor configured to generate a computation system calibration signal to configure the loss computation system based on the calibration value.

20. An agricultural harvester, comprising:
a crop processing system configured to process crop engaged by the agricultural harvester;
a loss sensing system configured to sense crop loss from the crop processing system and generate a loss signal indicative of the sensed crop loss;
a loss injection system configured to inject material into the loss sensing system;
a sample injection control system configured to control the loss injection system to inject a known quantity of material into the loss sensing system; and
a calibration system configured to generate a calibration value based on the injected known quantity of material and the sensed crop loss, and generate a control signal to configure the loss sensing system based on the calibration value.
